(19) United States
(12) Patent Application Publication
(10) Pub. No.: US 2017/0112100 A1
(43) Pub. Date: Apr. 27, 2017

(54) RETAINING DEVICE FOR METERED DISPENSING OF A FEED ELEMENT TO DOMESTIC ANIMALS

(71) Applicant: Sonja Labitzke, Mechernich (DE)

(72) Inventor: Sonja Labitzke, Mechernich (DE)

(21) Appl. No.: 15/344,800

(22) Filed: Nov. 7, 2016

Related U.S. Application Data
(63) Continuation of application No. PCT/EP2015/059291, filed on Apr. 29, 2015.

(30) Foreign Application Priority Data
May 7, 2014 (DE) 102014106385.6

(51) Int. Cl. A01K 15/02; A01K 5/01

(52) U.S. Cl. CPC A01K 15/026; A01K 5/0114

(57) ABSTRACT

A retaining device for metered dispensing of a feed element to domestic animals, the retaining device including an elongated base element including an elongated cavity having a longitudinal axis and configured to receive a segment of the feed element; a fixation device including a fastening element configured to fixate the segment of the feed element in the cavity wherein the fastening element extends substantially perpendicular to the longitudinal axis of the cavity, wherein the fastening element is configured to penetrate the segment of the food element so that a detachable positive-locking connection is established between the fastening element and the food element, and wherein the fixation device includes an actuation element which is arranged in a fixation position of the fixation device in a recess in a surface of the main element.

### RELATED APPLICATIONS

This application is a continuation of International Application PCT/EP2015/059291 filed on Apr. 29, 2015 claiming priority from German Patent Application DE 10 2014 106 385.6 filed on May 7, 2014, both of which are incorporated by their entirety by this reference.

### FIELD OF THE INVENTION

The invention relates to a retaining device for controlled dispensing of a feed element to domestic animals including an elongated base element which includes an elongated cavity with a longitudinal axis for receiving a section of the feed element and a fixation device for fixating a section of the feed element in the recess.

The invention also relates to a feed element for domestic animals which is easily retainable by the retaining device according to the invention.

Domestic animals like dogs of any type require tough feed elements for cleaning their teeth and in order to satisfy their need for chewing, wherein the feed elements are for example configured as dog bones or rod shaped chewing articles made from various organic pressed and/or dried materials. Since dogs are engorgers by nature they attempt to swallow chewing articles unchewed until the chewing articles have come down to a certain size by the chewing. Due to the hard structure of the chewing articles dogs are often unable to swallow an unchewed residual piece. It can rather happen that the unchewed residual piece is stuck in the esophagus of the dog which compresses a cross section of the wind tube of the dog which can lead to the suffocation of the dog in a worst case scenario.

On the other hand side large swallowed residual pieces in the stomach and intestines can lead to complications through inflammation and blockage so that a residual piece of a chewing article should be taken away from the dog as a matter of principle. Taking the residual piece away however is often difficult for the dog owner since dogs can run away or defend the food. Additionally it is difficult to remove the residual piece from the jaws since it has become very slippery from the chewing. This is caused by the fact that the food material softens during chewing and releases collagen. This collagen is a sticky protein which contaminates the fur of the dog and the flooring of an apartment and which sticks together after drying.

### BACKGROUND OF THE INVENTION

These problems have been addressed in the art. U.S. 2006 01 34 278 A1 discloses a retaining device for controlled dispensing of food materials which includes a hollow rod in whose interior space a conveying device and a fixation device for a chewing bar are arranged. The fixation device is configured as a clamping device which reaches around an end of a new chewing bar and which supports it within the support device. When the chewing bar is still new and thus has not been chewed on it is inserted by the conveying device into the retaining device so that it protrudes from the retaining device only by a short distance. Depending on the chewing progress the chewing bar is pushed by the dog owner piece by piece out of the retaining device. It is a disadvantage of this retaining device that it is only suitable for one type or one geometry of feed material wherein the feed material additionally has to include a circumferential groove that corresponds to the clamping device. The dog owner is also unable to determine how long the piece is that still remains in the retaining device so that it can happen that the dog owner moves the food material too far out of the interior space of the retaining device by accident so that the residual piece comes loose from the retaining device when the dog chews on it. Since a dog also chews on the retaining device itself the rather complex mechanism of the conveying device has it problems since it can be damaged by the bite of the dog so that the entire retaining device becomes unusable. Furthermore the actuation element of the conveying device which is configured as a sphere is accessible for the dog which can therefore also manipulate or actuate the actuation element or even bite it apart.

WO 01197056A1 discloses a similar retaining device as U.S. 2006 0134 278 A1 wherein a threaded rod is arranged in an interior of the retaining device which shall either thread into a soft food material or thread into a corresponding thread of a special food material. Also this known retaining device is only suitable for special chewing bars and the actuation element for adjusting the piece protruding from the retaining device is accessible for the dog and thus also actuatable for the dog.

Furthermore a retaining device for dispensing a feed element is known from U.S. Pat. No. 6,076,486A1 which does not focus on controlled dispensing but focuses on positioning the feed element so that it becomes easy to chew. Thus, the feed element shall be clamped in the retaining device so that it protrudes from the ground and can be easily gripped by the dog. Accordingly the retaining device is used as a stand for the feed element.

### BRIEF SUMMARY OF THE INVENTION

Thus, it is an object of the invention to develop an alternative retaining device for metered dispensing of a feed element which is characterized by a simple and robust configuration and which is suitable for supporting different feed elements. Additionally it shall not be possible for a pet to manipulate the fixation device. With respect to the feed element recited supra it is an object of the invention to provide a feed element which is suitable for a fixation in the retaining device according to the invention.

Improving upon the retaining device described supra the object is achieved by a fastening element of the fixation device which fastening element extends transversal to a longitudinal axis of the cavity wherein the fastening element is configured to penetrate a segment of the food element so that a detachable positive-locking connection is established between the fastening element and the feed element, and wherein the fixation device includes an actuation element which is arranged in a fixation position of the fixation device in a recess in a surface of the main element. Advantageously the fastening element can also extend in a fixation position perpendicular to the longitudinal axis of the recess. The fixation device according to the invention facilitates a particularly simple fixation of the feed element from a technical point of view. Contrary to the known support devices for metered dispensing of feed elements a conveying device is omitted and adjusting a section of the feed element that protrudes from the retaining device is performed manually by a renewed fixation of the feed element at a different location, Thus, it is necessary that the feed element is penetratable by the fastening element over its length which is either obtained in that the feed element is made from a soft material that is penetratable by the fastening element and which has a consistency that is stable enough so that it does not tear or break. These are for example pressed dog snacks. Furthermore holes can also be provided in the feed element wherein the fastening element can be run through the holes. It is also conceivable to provide the feed element with corresponding loops or eyelets through which the fastening element can be run. When the feed element is made from a soft material its support is continuously adjustable in the retaining device.

In order to dispense the feed element in a metered manner the feed element is positioned in a first position in its original condition where it has not been chewed upon yet wherein the feed element extends into an entire receiver so that only a section of the feed element protrudes from the support device. When the protruding section is chewed off by a pet the feed element initially has to be disengaged from the retaining device for further metering in that the fastening element is removed from the feed element. Subsequently the feed element is pulled from the recess of the retaining device as desired and attached again by the fastening element which penetrates the feed element at another location.

A fixation device of this type is characterized by mechanical simplicity and thus by a high level of robustness and durability.

Since the actuation element is arranged in one fixation position of the fixation device in a recess arranged at an outer surface of the base element the actuation element cannot be gripped by a pet and manipulated. Thus, it is already sufficient when the actuation element is arranged in the recess to a large extent, thus for example by 80% or advantageously by more than 90% so that chewing on the protruding portion of the actuation element by the pet cannot lead to an actuation or destruction of the actuation element. Advantageously the actuation element can also be inserted into the recess completely which means that a surface of the actuation element in the fixation position relative to an outer surface, thus a visible surface of the base element is arranged flat, thus in alignment or recessed inward towards a base of the recess so that the actuation element does not protrude beyond the surface of the base element and can thus cannot be gripped or manipulated by a pet at all. The actuation element can be provided so that it is accessible and actuatable by a person without tools wherein it is advantageous when the dimensions of the recess are larger by an amount than the outer dimensions of the actuation element so that one or plural fingers fit into the intermediary space. An actuation element of this type could be configured as a turn button wherein a gap between an outer circumference of the turn button and the recess should be provided around the turn button. Another conceivable configuration of the actuation element can be configuring the actuation element as a wing nut with a washer so that the dimensions of the recess only have to exceed the dimensions of the wing nut so that a frictionless rotation of the wing nut can be performed in the recess. Thus, it is for example sufficient to provide the recess so that it is larger by one or two mm than the wingnut which is namely configured so that it facilitates positioning the fingers.

Alternatively the actuation element can be configured so that it is accessible without tools but actuatable by a tool like for example an Allen wrench. It is an advantage of the hidden actuation element or of the actuation element recessed into the base element that a dog cannot sufficiently reach it or cannot reach it at all with its teeth so that the dog can neither actuate nor destroy the actuation element.

With respect to the actuation of the fastening element it is advantageous when the recess has a center axis which extends parallel to a center axis of the fastening element in the fixation position. Thus, a free movement of the fastening element is possible in a longitudinal direction and fixating and disengaging the feed element is particularly simple.

An advantageous embodiment of the invention provides that the fastening element includes a first end with a thread and a second end with a head, wherein the first end can be threaded into a corresponding inner thread of the fixation device by rotating the head wherein the fixation device is provided in the base element. The head of the fastening element is thus configured as an actuation element which is arranged in a fixation position within the recess. The interior thread can either be provided as a separate component for example configured as a sleeve with an inner thread or as a wing nut with a washer or in the base element itself. A configuration of the fastening element of this type is characterized by low cost, robustness and simple handling.

An alternative embodiment of the fixation device is characterized in that the fastening element is formed by a pin which is provided with a support rod extending parallel to the longitudinal axis of the recess and transversal to the pin wherein the support rod is elbowed so that a longitudinal axis of the support rod is arranged offset to the longitudinal axis of the recess, wherein the support rod is moveable in an opening at a second end of the base element in a direction of its longitudinal axis and provided with a cap in a fixation position at its end arranged opposite to the pin wherein the cap fixates the support rod at the base element. Also this variant of the fixation device is advantageous with respect to simple operability and engineering. The elbow in the support rod is required so that the support rod extends at an outer edge of the recess and thus leaves sufficient free space in the recess in order to house the feed element therein in particular in its starting condition, Fixating the support rod with the cap can be performed through a clamping connection, wherein the cap includes a section which is provided for insertion into the opening at the second end of the base element and which has a larger outer diameter than the opening. The cap can also include a conical section in the portion to be inserted. The cap can have an inner thread into which an outer thread of the support rod is threaded which outer thread is arranged opposite to the pin. The cap can have a shoulder in this embodiment which prevents a sliding of the cap through the opening in the base element. Advantageously the second end of the base element is configured so that the entire cap is recessed in its fixation position in the base element and thus not accessible for the pet.

In case the feed element is made from a penetratable material it can be furthermore advantageous when the fastening element is configured with a tip or pointed at a side oriented away from the actuation element so that a penetration through a material can be performed more easily and requires less force.

A particularly advantageous geometry of the retaining device is obtained when the base element has a longitudinal axis which extends parallel to the longitudinal axis of the recess. Also with respect to producing the base element advantages are obtained by the parallel longitudinal axes of recess and the base element. It can be furthermore provided that the longitudinal axes of recess and base element coincide so that a retaining device with a rotation symmetrical cross section can be produced which is particularly well suited as a toy or chewing device for pets.

In order to facilitate a variable application of the retention device it is provided according to another embodiment of the invention that the recess includes at least two sections with different cross sectional surfaces, wherein a section oriented towards the first end of the base element has a larger cross sectional surface than a section oriented towards the second end of the base element, wherein a transition between the at least two sections can occur incremental or continuously. In particular the retaining device is also suitable in this case for feed elements shaped as a bone or with knotted ends, wherein the knot or the bone end can be arranged in the section with the larger cross sectional surface.

With respect to a particularly simple production of the retaining device it is advantageous when the cross sectional surface or the different cross sectional surfaces of the recess are circular. Alternatively only the section of the recess oriented towards the second end of the base element can have a circular cross section while the section of the recess oriented towards the first end of the base element can have a rectangular cross section. The rectangular shape is advantageous with respect to bones that are mostly flat and provided with an end that has a rectangular cross section.

When the base element has a larger outer circumference in a first section than in a second section wherein a transition between the first section and the second section can be incremental or continuous this yields a bell shape which is suitable in particular when the pet owner wants to motivate his pet with the retaining device to play since the second section with its smaller circumference can be gripped and held more easily. Furthermore the bell shaped configuration is advantageous since it prevents that the feed element can be pushed between legs of pieces of furniture by the pet.

The base element can have an opening at its second end by which a rope shaped material is supported and fixated. This is in turn particularly advantageous when the retaining device is also used for playing with the pet. The opening which can have a diameter between 5 mm and 12 mm can extend to the recess so that a pass through opening is provided along the longitudinal axis of the base element which pass through opening then typically has various diameters since the opening typically has a smaller diameter than the recess. Alternatively the opening can also be configured so that it is supported in a semi-circle through which a thread can be run and knotted so that the opening does not completely extend up to the recess.

Furthermore the base element can be provided at a first end of the cavity which forms an opening cross section for inserting a feed element with flexible lips which extend perpendicular to the longitudinal axis of the recess and which extend from a circumference of the recess in a direction towards a center of the recess. This makes the opening cross section independent from the fact whether the retaining device is provided with a feed element or not covered by the flexible lips so that the cavity and the fastening element arranged therein is substantially protected against saliva from the pet. In case the retaining device is configured with a feed element the flexible lips bend accordingly, namely into the recess. When the portion of the feed element penetrating from the base element is chewed off completely the lips move back into their starting position and cover the opening cross section so that the pet cannot get to the residual piece which has remained in the base element. Alternatively the lips can also be configured short so that they only reach up to a feed element arranged in the retaining device. Advantageously the base element is made from a flexible material, advantageously natural rubber or another elastomeric material since these materials are well suited for pet toys. Alternatively the base element can be made from a hard tooth saving material, advantageously from hard wood when the retaining device as such shall also be used as a toy.

With respect to the dimensions of the retaining device it has proven to be particularly advantageous when the base element has a length of between 60 and 150 mm and a maximum extension perpendicular to the longitudinal axis between 45 mm and 150 mm. The receiver which is adapted accordingly to the outside dimensions of the base element has a size which can receive a large portion of the commercially available feed elements. Accordingly the receiver can have a total length of 50 mm to 135 mm. The retaining device is particularly practical when the recess has a length which corresponds to approximately 80%, advantageously even 90% or more of the length of the base element. In case the cross section of the cavity is approximately rectangular the cross section at the first end of the base element should have a minimum width of between 15 mm and 45 mm and a maximum width of between 25 mm and 70 mm. The maximum width of the embodiment is advantageous because also flat chewing articles like tendons, ears or parts cut into strips can be inserted into the recess. In case the recess has different cross sectional surfaces in sections the cross section in the portion of the respective section at the first end of the base element should be selected wide accordingly. In particular for flat chewing articles it has proven advantageous when the base element is configured with lips since the chewing articles can be run diagonally through opposite incisions of the lips so that good stability of the chewing article is obtained and the chewing article does not tend to rattle. The diagonal insertion of the feed material yields correspondingly larger insertion width.

When the recess is divided into two sections over its length the section oriented towards the first end of the base element can have a length between 19 mm and 48 mm and the section oriented towards the second end of the base element can have a length between 33 mm and 85 mm. When the upper section is configured with a circular cross section the diameter can be between 13 mm and 35 mm.

In order to counteract a chewing at the fixation device it can be made from a material which includes a bitter additive. Alternatively the fixation device can be coated with a bitter substance.

When the base element is made from a material that is mixed with a phosphorescent substance the retaining device is also visible quite well in the dark or in twilight.

With respect to a feed element for pets the object recited supra is achieved in that the feed element is provided with at least one, advantageously at least two pass through bore holes wherein the pass through bore holes extend perpendicular to a longitudinal axis of the feed material and at least one pass through bore hole is arranged at one end and/or in a center of the feed element. A feed element of this type can be fixated by the retaining device according to the invention in a particularly simple and quick manner.

It is also conceivable to use an elongated feed element which is provided in a portion of both ends with a hole, a loop or similar or whose two ends are made from a penetratable material so that a retaining device according to the invention can be attached at both ends and a throwing toy is provided.

It is appreciated that the different features of the dependent claims can be implemented individually or in groups in any combination in embodiments of the invention.

### BRIEF DESCRIPTION OF THE DRAWINGS

The invention described supra is subsequently described in more detail with reference to embodiments which are illustrated in drawing figures, wherein

FIG. 1 illustrates a view of a first retaining device according to the invention;

FIG. 2 illustrates a vertical sectional view through the retaining device according to FIG. 1;

FIGS. 3 and 4 respectively illustrate a vertical sectional view through a second retaining device according to the invention;

FIG. 5 illustrates a vertical sectional view through a third retaining device according to the invention;

FIG. 6 illustrates a front view of the retaining device according to FIG. 5;

FIG. 7 illustrates a rear view of the retaining device according to FIG. 5;

FIG. 8 illustrates a bottom view of the retaining device according to FIG. 5; and

FIG. 9 illustrates a detail of the bottom view according to FIG. 8.

### DETAILED DESCRIPTION OF THE INVENTION

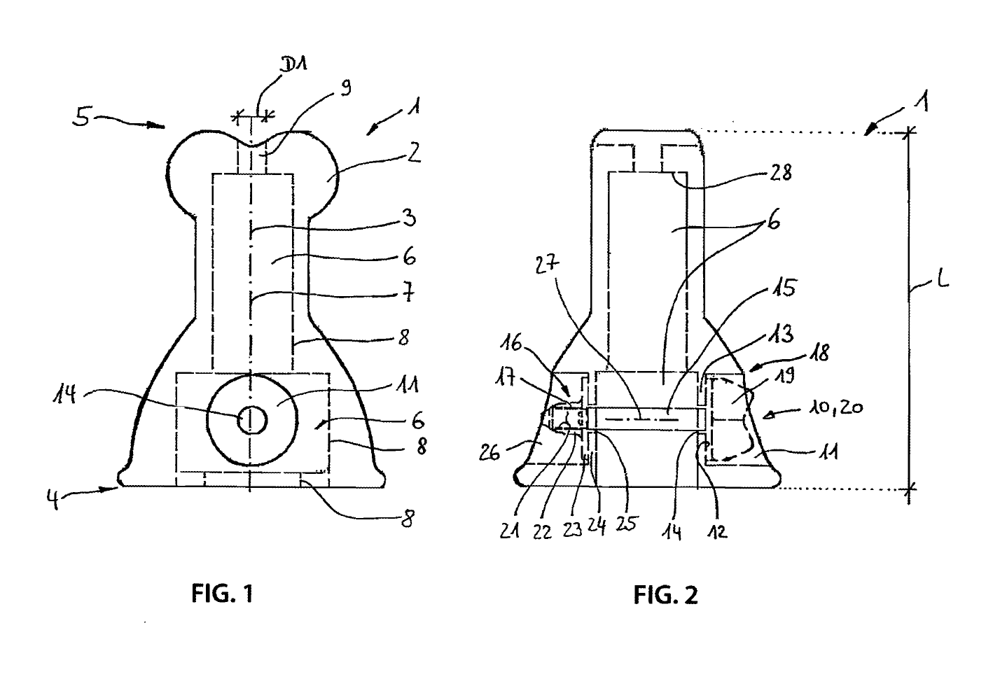

In FIG. 1 illustrates a first retaining device 1 for metered dispensing of a feed element to pets in a side view wherein the feed element itself is not illustrated in this figure. The retaining device 1 includes an elongated base element 2 with a longitudinal axis 3 and a first end 4 and a second end 5. Starting from the first end 4 the cross section of the base element 2 tapers continuously towards a center, then remains constant for a few cm and expands in the view according to FIG. 1 again a little in a direction towards the second end 5, wherein the second end 5 is formed like a bone end. Overall the base element 2 is bell shaped. Within the base element 2 an elongated cavity 6 is fabricated wherein the cavity 6 has a longitudinal axis 7 which coincides with the longitudinal axis 3 of the base element 2. The cavity 6 which is indicated in FIG. 1 with dashed lines 8 extends from the first end 4 of the base element 2 to the second end 5 of the base element 2, whereas the cross sectional surface of the cavity 6 decreases in two large increments. At the second end 5 the cavity 6 has a circular cross section with a diameter D1 of 10 mm, wherein this section of the cavity 6 can also be designated as an opening 9 in the base element 2 through which a non-illustrated rope or thread is run and is fixable by a knot within the actual cavity 6 of the base element 2. Alternatively providing the opening 9 can be omitted so that the cavity 6 terminates shortly before the second end 5 of the base element 2. When the opening 9 at the second end 5 is not considered the cavity 6 extends over approximately 90% of a length L of the base element 2.

The retaining device 1 includes a fixation device 10 which is not illustrated in FIG. 1. FIG. 1 only illustrates a recess 11 in the base element 2 which has a circular cross section. At a base 12 of the recess 11 which is formed by a wall 13 between the recess 11 and the cavity 6 a bore hole 14 is provided through which a fastening element of the fixation device 10 can be run as illustrated in FIG. 2.

FIG. 2 illustrates a vertical sectional view through the retaining device 1 according to FIG. 1 in which the geometry of the cavity 6 within the base element 2 with the incremental change of the cross sectional surface and the geometry of the recess 11 for introducing the fixation device 10 are visible quite well.

Furthermore the configuration of the fixation device 10 is visible quite well from FIG. 2 which includes the fastening element 15 which is provided at a first end 16 with a thread 17 and at a second end 18 with an actuation element 19 configured as a wing nut. The fixation device 10 is arranged in the illustrated position in a fixation position 20 where the fastening element 15 is threaded into a corresponding inner thread 21 within the base element 2 so that the wing nut is embedded almost completely in the recess 11. The actuation element 19 penetrates only in an upper portion for a few millimeters above a surface of the recess 11 that is arranged opposite to a base 12 of the recess. Alternatively the actuation element 19 or the recess can have a corresponding geometry so that the actuation element completely penetrates the recess 11 in the fixation position.

The inner thread 21 which can be considered an element of the fixation device 10 is formed by a wing nut 22 with an inner thread 21 which includes a shoulder 23 like a washer wherein the wing nut 22 contacts a wall 24 in the base element 2 with the shoulder 23, wherein the wall 24 includes a corresponding bore hole 25 for passing the fastening element 15 through. Accordingly the inner thread 21 according to FIG. 2 is not an integral component of the base element 2 but rather a separate component. When fixating a feed element in the feed retaining device 1 is it required to also hold the wing nut 22 when tightening the wing bolt. However, it is also easily conceivable to provide the inner thread directly in the base element so that it is an integral component of the base element. The wing nut 22 in analogy to the actuation element 19 is arranged in a corresponding second recess in the base element 2 wherein the wing nut 22 completely disappears in the recess 26 in the fixation position 20.

The bore hole 14 is also provided in the wall 13 between the recess 11 and the cavity 6 which forms the cavity base 12 wherein the bore hole 14 facilitates passing the fastening element 15 through and connects an interior space of the recess 11 with an interior space of the cavity 6. Thus, inserting and extracting the fastening element 15 is possible in a direction of a longitudinal axis 27 of the fastening element 15 without having to pivot the fastening element 15.

In order to attach a feed element that is in the original condition, thus has not been chewed on in the retention device 1 the fastening element 15 has to be disengaged from the inner thread 21 by rotating the actuation element 19 so that it can be pulled back in a direction of the longitudinal axis 27 of the fastening element 15, thus perpendicular to the longitudinal axis 7 of the cavity 6 so that it sufficiently or completely releases the interior of the cavity 6 and the feed element can be brought into its proper position. The arrangement and alignment of the recess 11 and of the fastening element 15 is thus selected so that pulling the fastening element out of the recess 11 can be performed along its longitudinal axis 27. The pull out is thus performed transversally, advantageously perpendicular to the longitudinal axis 7 of the cavity 6. Typically an elongated feed element is selected which is inserted in a first step as far as possible in to the cavity 6. In an extreme case the feed element contacts the base 28 of the cavity 6 with an end of the feed element. When the feed element is positioned accordingly the fastening element 15 can be supported by the feed element and threaded into the internal thread 21 so that the feed element is fixated by a form locking connection in the retaining device 1. Passing the fastening element 15 through can be performed in that it penetrates the feed element made from a corresponding material. Alternatively the feed element can be provided with a bore hole or a loop through which the fastening element 15 is run.

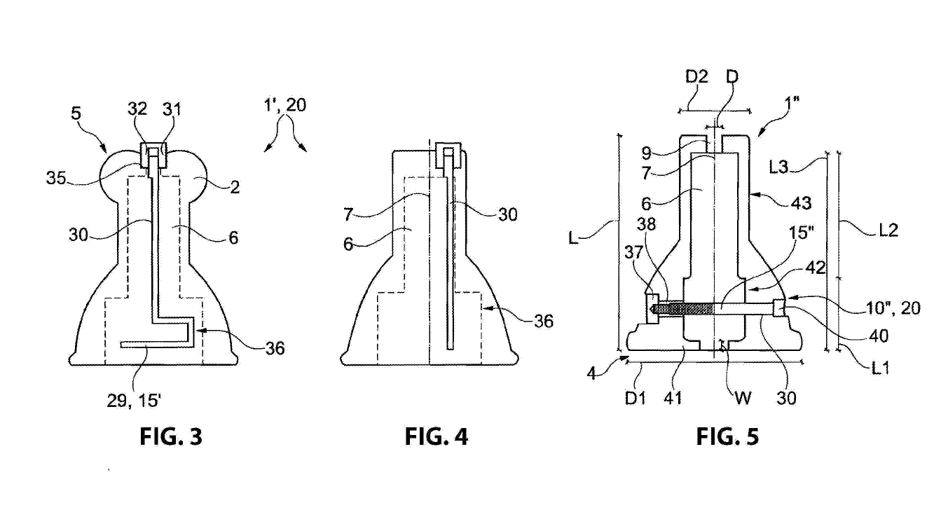

FIGS. 3 and 4 illustrate another retaining device 1′ according to the invention respectively in a vertical sectional view, wherein the two vertical sectional views are rotated relative to each other by 90°. The base element 2 and the cavity 6 arranged therein are configured analogous to the elements of the retaining device 1 according to FIGS. 1 and 2. The fixation device 10 of the retaining device 1 that is arranged in the fixation position 20 includes a fastening element 15′ configured as a pin 29 and a support rod 30 attached thereon and extending transversal thereto which protrudes into an opening 31 oriented away into an opening 31 at the second end 5 of the base element 2 at an end oriented away from the pin 29 and which support rod 30 is fixated at this location with a cap 32. For this purpose the support rod 30 includes an outer thread 33 at its end oriented towards the cap 32, wherein the outer thread 33 is threadable into a corresponding inner thread 34 within the cap 32. The fixation of the cap 32 at or in the base element 2 can thus be achieved by plural measures. The illustrated option is that the opening 31 at the second end 5 of the base element 2 is contracted on a side oriented towards the cavity 6 so that the support rod 30 can be passed through, however the cap 32 is arranged in the fixation position 20 on the seat 35 thus formed shaped. Alternatively the cap can be configured conical so that it cannot slide through the opening 31 either. The cap can also be provided with a circumferential shoulder on a side oriented away from the cavity 6 wherein the circumferential shoulder is inserted in the fixation position at the base element or in another recess provided in the base element.

The support rod 30 is provided with an elbow in a transition portion 36 between the pin 29 and the support rod 30 so that the support rod 30 extends in the vertical sectional view according to FIG. 3 along the longitudinal axis 7 of the cavity 6 in the vertical sectional view according to FIG. 4 however extends laterally offset to the longitudinal axis 7 of the cavity 6 so that it contracts the inner cavity of the base element 2 formed by the cavity 6 as little as possible. This way sufficient space is provided to receive a feed element that is not illustrated in the figures. Alternatively the support rod however can also coincide in FIG. 4 with the longitudinal axis of the recess, wherein the support rod should then be extendable in a telescoping manner for providing a potentially required cargo space and lockable in various telescope positions.

In order to provide the retaining device with a feed element the cap 32 is disengaged from the support rod 30 so that the cap is movable in a longitudinal direction of the cavity 6. The support rod 30 is then pushed at least far enough from the cavity 6 until the fastening element 15′ is arranged outside of the base element 2 so that the support rod can be passed through a provided opening or eyelet of the feed element. Alternatively the pin 29 can also penetrate a feed element that is made from a suitable material. Thereafter the support rod 30 can be inserted into the opening 31 again and can be fixated with the cap 32 so that the feed element is attached in the retaining device 1′.

A third embodiment of the retaining device 1″ according to the invention is illustrated in FIGS. 5-9, wherein FIG, 5 illustrates a vertical sectional view through the retaining device 1″, wherein the retaining device 1″ differs from the retaining devices 1, 1′, described supra in particular by an alternatively configured fixation device 10″ which is illustrated again in a fixation position 20. The fixation device 10″ is made from a fastening element 15″ extending perpendicular to the longitudinal axis 7 of the cavity 6, wherein the fastening element is configured as a screw and a counter piece 37 with a corresponding inner thread 38, wherein the counter piece 37 is configured as a separate component again. Alternatively the counter piece can be fixated thus positioned non movable in the base element or provided integrally in one piece with the base element. The screw penetrates the base element 2 from one side to another side, wherein the base element 2 includes a corresponding bore hole 39. On a side of the base element 2 associated with a bolt head 40 the base element 2 includes a recess 11° for the bolt head 40 wherein the bolt head 40 is sized so that it completely receives the bolt head 40 in a fixation position 20 of the bolt so that the bolt head 40 does not protrude beyond a surface of the base element 2.

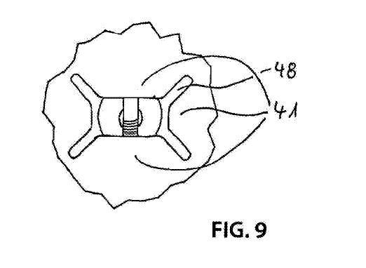

The opening 9 in the base element 2 has a diameter D of 10 mm. At the first end 4 of the base element 2 the base element 2 is provided with elastic lips 41 which partially cover the opening cross section of the cavity 6 at the first end 4. The wall thickness W of the lips 41 is 5 mm, wherein a geometry of the lips 41 is clearly evident from FIGS. 8 and 9.

A length L of the retaining device 1″ is 125 mm and the cavity 6 has a length L3 of 110 mm wherein the cavity 6 in a first section 42 has a length L1 of 35 mm and a larger cross sectional surface than in a second section 43 in which the recess has a circular cross section with a diameter of 28 mm. The second section 43 has a length L2 of 70 mm.

The base element 2 has a circular cross section with a diameter D1 of approximately 100 mm at a first end 4, wherein the cross section besides an initial shoulder up to a medium height of the base 2 continuously tapers to a diameter D2 of 40 mm so that the base element 2 is bell shaped.

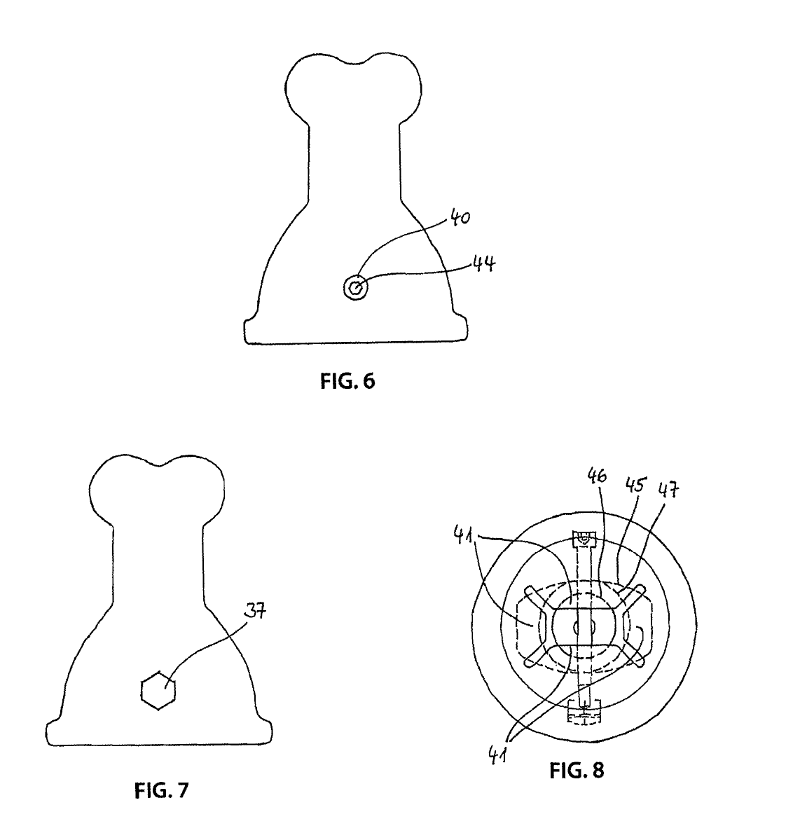

FIG. 6 illustrates a view of the retaining device 1 showing the screw head 40 with a hexagonal bore hole 44, whereas the counter piece 37 is provided in the view according to FIG. 7 with a hexagonal cross section on the surface of the base element 2. Therefore the fastening element 15″ is only operable with an Allen wrench.

FIG. 8 illustrates a bottom view of the retaining device 1″, wherein the portion of the lips 41 is illustrated in FIG. 9 in detail. In FIG. 8 the cross sections of the two sections 42, 43 of the cavity 6 are indicated by dashed lines 45, 46, wherein a dashed line 47 represents a transition between the two sections 42, 43. It is evident that the cavity 6 in the first section 42 has a substantially rectangular cross section, wherein the long sides are rounded so that an average width of the cross section is greater than the width of the cross section in an edge portion of the long sides. A rectangular, circular or oval embodiment of the first section is also conceivable.

It is in particular evident from FIG. 9 that the cavity 6 is covered by four lips 41 at a first end of the base element, wherein the lips are separated from each other by incisions 48.

### REFERENCE NUMERALS AND DESIGNATIONS

1, 1′ retaining device

2 base element

3 longitudinal axis of base element

4 first end

5 second end

6 cavity

7 longitudinal axis of recess

8 dashed line

9 opening

10, 10′, 10″ fixation device

11, 11′ recess

12 base of recess

13 wall

14 bore hole

15, 15′, 15″ fixation element

16 first end of fastening element

17 thread

18 second end of fastening element

19 actuation element

20 fixation position

21 inner thread

22 wing nut

23 shoulder

24 wall

25 bore hole

26 second recess

27 longitudinal axis fastening element

28 base

29 pin

30 support rod

31 opening

32 cap

33 external thread

34 internal thread

35 seat

36 transition portion

37 counter piece

38 inner thread

39 bore hole

40 bolt head

41 lip

42 first section

43 second section

44 hexagonal bore hole

45 line

46 line

47 line

48 incision

D, D1, D2 diameter

L1, L2, L3 length of base element

W wall thickness

What is claimed is:

1. A retaining device for metered dispensing of a feed element to domestic animals, the retaining device comprising:
an elongated base element including an elongated cavity having a longitudinal axis and configured to receive a segment of the feed element;
a fixation device including a fastening element configured to fixate the segment of the feed element in the cavity;
wherein the fastening element extends transversal to the longitudinal axis of the cavity,
wherein the fastening element is configured to penetrate the segment of the feed feed element so that a detachable positive-locking connection is established between the fastening element and the feed element, and
wherein the fixation device includes an actuation element which is arranged in a fixation position of the fixation device in a recess in a surface of the base element.

2. The retaining device according to claim 1, wherein the recess has a center axis which extends substantially parallel to a center axis of the fastening element or coincides therewith.

3. The retaining device according to claim 1,
wherein the fastening element includes a first end with a thread and a second end with a head, and
wherein the first end is threadable into a corresponding inner thread of the fixation device by rotating the head, and
wherein the inner thread is arranged in the base element.

4. The retaining device according to claim 1,
wherein the fastening element is formed by a pin which is provided with a support rod extending parallel to the longitudinal axis of the recess and transversal to the pin,
wherein the support rod is provided with an elbow so that a longitudinal axis of the support rod extends offset from the longitudinal axis of the recess,
wherein the support rod is movable in a direction of the longitudinal axis of the support rod in an opening at a second end of the base element,
wherein the support rod is provided with a cap at an end of the support rod arranged opposite to the pin, and
wherein the support rod is attachable at the base element by the cap in a fixation position of the support rod.

5. The retaining device according to claim 1,
wherein the recess includes at least a first section and a second section with different cross sectional surfaces,
wherein the first section oriented towards a first end of the base element has a greater cross sectional surface than the second section oriented towards a second end of the base element, and
wherein a transition between the first section and the second section is incremental or continuous.

6. The retaining device according to claim 1,
wherein the base element has a greater outer circumference in a first section than in a second section, and
wherein a transition between the first section and the second section is incremental or continuous.

7. The retaining device according to claim 1,
wherein the base element is provided with flexible lips at a first end of the cavity,
wherein the flexible lips extend transversal or perpendicular to the longitudinal axis of the cavity and extend from a circumference of the cavity in a direction towards the longitudinal axis of the cavity.

8. The retaining device according to claim 1, wherein the base element has a length of 60-150 mm and a maximum extension perpendicular to the longitudinal axis between 45 mm and 150 mm.

9. A feed element for domestic animals for a retaining device according to claim 1, the feed element comprising:
at least one pass through bore hole, advantageously at least two pass through bore holes,
wherein the at least one pass through bore hole extends perpendicular to a longitudinal axis of the feed element, and
wherein the at least one pass through bore hole is arranged at an end or in a center of the feed element.
